(19) United States
(12) Patent Application Publication
(10) Pub. No.: US 2012/0319557 A1
(43) Pub. Date: Dec. 20, 2012

(54) Active Matrix Display with Integrated Repair Structure for Open Lines

(75) Inventors: Thierry Kretz, Saint Jean De Moirans (FR); Hugues Lebrun, Coublevie (FR)

(73) Assignee: THALES, Neuilly-sur-Seine (FR)

(21) Appl. No.: 13/580,109

(22) PCT Filed: Feb. 10, 2011
(86) PCT No.: PCT/EP2011/051986

§ 371 Date: Aug. 20, 2012

(30) Foreign Application Priority Data
Feb. 19, 2010 (FR) 1000701

(51) Int. Cl. H05B 43/00

(52) U.S. Cl. 313/306

(57) ABSTRACT

In a display, an integrated repair structure for open lines of an active matrix array uses conducting repair elements with half-rings around the useful display region. Each repair element is assigned to the repair of only one group of lines of the array which cross the two open legs of the half-ring. An open line is then repaired by creating a connection at each of the two crossing points of this line with the two open legs of the half-ring of a repair element. The loop-closing is provided at least by the segment which connects the two open legs. The repair structure advantageously minimizes the stray couplings and the charge on the lines, and is inexpensive, while allowing a large number of lines to be repaired. It is especially suitable for large displays or high-resolution displays.

The present invention relates to the repair of the address lines of an active matrix display, for repairing breaks in these lines. It is notably applicable to liquid crystal displays or to organic light-emitting diodes.

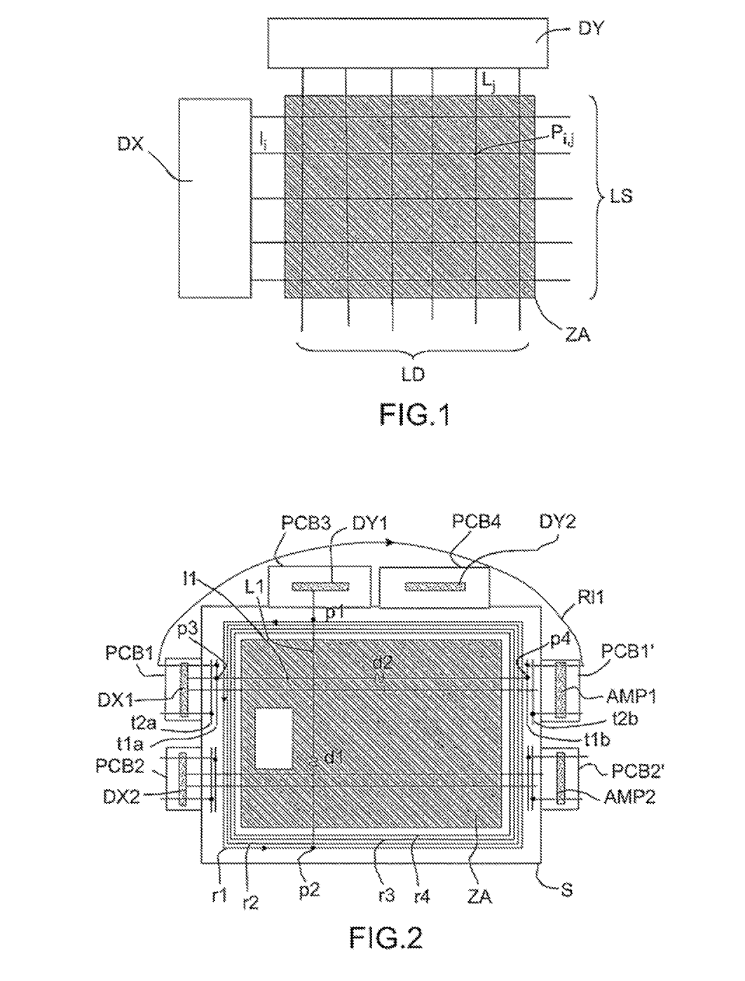

As illustrated schematically in FIG. 1, an active matrix display usually comprises a 2D matrix array of conducting lines, allowing image dots of the display to be addressed. The array comprises a first set of lines LS, with lines running in a first direction and a second set of lines LD, electrically insulated from the first set, with lines running in a second direction orthogonal to the first. The region where the lines cross defines a useful region ZA of the display, containing the image dots P_{i,j}. The terminations of the conducting lines are situated outside of the useful region, and are connected to corresponding control circuits DX, DY, either external or integrated.

In practice, breaks in the lines can occur in the useful region ZA during the process of fabrication of the display. Breaks can also be caused in order to isolate a short-circuit defect between two conducting lines. If an address line of the display is interrupted, a control signal applied to a termination of this line will not propagate up to the other termination of the line: image dots associated with this line will not be able to be addressed, which constitutes a major defect.

In order to improve the fabrication yield of the displays, a repair of these open-line defects is usually carried out by laser. This laser repair is based on a loop-closing, outside of the useful region of a display, of the two terminations of an open line, in such a manner as to allow the propagation of the signal over the line from these two terminations. In practice, in a repair region, a connection between each of the two terminations of the line to be repaired and a respective conductor, via which the two terminations will be closed-looped, is created by laser. This loop-closing is generally carried out in two ways, which are illustrated in FIG. 2.

A first way uses a repair structure comprising repair conducting rings r1, r2, r3, r4 formed on the substrate S which carries the active matrix array, in a part outside of the useful region ZA. These rings cross the lines of the array. In the crossing region, the lines of the array and the rings r1, r2, r3, r4 are separated by at least one insulating layer. An open line, in the example L1, is then repaired by forming, by laser, a connection to the two crossing points p1, p2 of this line with one of the repair rings, in the example r1. The signal applied by the decoder DY1 will propagate via the two sides of the line L1: via the side which drives this circuit DY1, and via the other side of the line L1 via the portion of ring r1 between the two points of contact p1 and p2.

Such a repair structure integrated onto the substrate of the array is usually employed for small displays. This is because this structure allows, at the most, as many defects to be repaired as there are repair rings. The larger the display or the higher its resolution, the greater the potential number of lines of the active matrix array will be. It is difficult to increase the number of repair rings on the substrate. Furthermore, the laser impact must have a minimum surface area in order to form the contact between the 2 metals without however causing a break in conduction of the line L1. The laser repair therefore assumes a large enough crossing surface area between the line and the ring to break through the insulator separating them and to make the junction between the two conductor levels. This ring/line crossing surface area induces a non-negligible stray capacitance, and the part of the ring which closes the circuit between the two terminations of the line increases the equivalent resistance of the line. As a result, the RC load of a line repaired by such a ring is increased with respect to the other lines of the array. For large displays or high-resolution displays, this increase in the RC load of the repaired lines with respect to the other lines can be seen on the screen, creating a cosmetic defect.

A second way, illustrated in the same FIG. 2, uses a repair structure with external interconnection circuits in order to provide the loop-closing. It is based on dividing up the lines into groups, by associating a set of conducting repair sections with each group. These sections are formed on the substrate of the active matrix array, orthogonally to the lines of the group whose repair they must enable, and are furthermore connected to contact areas on the substrate to allow loop-closing by an external circuit which will be connected to these contact areas.

In the example, this repair structure is used for the lines which run from right to left in FIG. 2, such as I1.

The sections are distributed along either side, right-hand and left-hand, of the useful display region ZA, and in pairs, such that each conducting section, t1a for example, on one side of the array, corresponds to an opposing conducting section on the other side of the array, the section t1b in the example. Each repair set groups several pairs of sections, with sections disposed in parallel on each side, and is assigned to the repair of the lines which cross the sections of this set. Each set allows as many open lines to be repaired as the number of pairs it comprises.

Connection lines are provided that connect the various connection sections to contact areas provided for connection to a printed circuit such as a TAB (“Tape Automatic Bonding”) circuit or PCB (“Printed Circuit Board”). In the example, there is thus a printed circuit on each side, for each group of lines, i.e. PCB1 and PCB1′ for the first group and PCB2 and PCB2′ for the second group. The circuits PCB1 and PCB2 incorporate the circuit for controlling the corresponding lines, DX1, DX2. The circuits PCB1′ and PCB2′ will generally comprise amplifiers AMP1 and AMP2 with unity gain designed to increase the current available on the repaired lines.

An open line, in the example I1, is then repaired by forming a connection at each of the two crossing points p3, p4, of this line with a repair element of a pair, t1a and t1b, respectively. Each pair, in the example (t1a, t1b) or (t2a, t2b), allows a line of the group to be repaired. In the simplified example illustrated, the lines are separated into two groups, each group being driven by a corresponding control circuit DX1, DX2, and each group comprising a set of two pairs of repair sections, allowing two open lines within each group, at the most, to be repaired. In practice, this solution is generally adopted for large displays. In a practical example applied to a display with 2304×3072 pixels, 2304 lines may thus be divided up into 6 groups of 384 lines, with one set of 3 pairs of repair sections per group.

This repair structure, with a specific external interconnection and distribution of the repair of the open lines over various groups, allows a large number of defects to be repaired. It is therefore advantageous for large displays, or for high-resolution displays. But it has the drawback of being costly, owing to the use of external interconnection circuits, which are specific, in other words customized, circuits. Furthermore, it can require amplification circuits for the signals to be incorporated into these interconnection circuits for the lines of the array which are highly capacitive.

For these large displays, or for high-resolution displays, it would therefore be advantageous to find other repair structures that are less costly. It is necessary to both allow the repair of all the possible open-line defects, whose number can be estimated for a given factory and product, without degrading the characteristics of the display, in other words by reducing the impact of the repair structure in terms of stray resistance and capacitance, and without recourse to specific external interconnection circuits.

The present invention provides a solution to this problem, in a repair structure for open lines of an active matrix array, using conducting repair elements each comprising a half-ring formed around the useful display region, each element/half-ring being assigned to the repair of only one group of the lines of the array which cross the two open legs of the half-ring. An open line is then repaired by creating a connection at each of the two crossing points of this line with the two open legs of the half-ring of a repair element. The loop-closing is at least provided by the segment that connects the two open legs of the half-ring.

The invention therefore relates to an active matrix display, the active matrix comprising a useful region defined by the crossing region of a first set of lines running in a first direction and of a second set of lines running in a second direction, orthogonal to the first, and elements for repairing open line defects in at least one set of lines amongst said first and second sets, formed on the active matrix substrate outside of said useful display region, where each repair element is a line formed of a half-ring with two open legs disposed opposite one another, on either side of the useful region, characterized in that in said at least one set of lines:
the lines of said set are divided up into groups of lines,
only one repair element is assigned to each group of lines of said set, allowing the repair of a line in this group of lines, and its two open legs each cross at least the lines of said group of lines to which it is assigned on either side of the useful region,
each repair element has a width of conductor which is
   substantially constant over the length of a repair region corresponding to the crossing region in which it crosses the lines of the group of lines to which it is assigned, said width in the repair region being defined in order to allow a repair by laser, and
   variable outside of this repair region, with a greater width outside of the crossing regions with a conducting line of the matrix than in said crossing regions in order to optimize the capacitive coupling and the access resistance of the lines.

According to one aspect of the invention, in the case of a display of the type with driver(s) integrated onto the active matrix substrate, in which the repair elements of a set of lines, from amongst said first and second sets of lines of the active matrix array, are disposed on the active matrix substrate beyond the integrated driver which controls the lines of the other set.

Preferably, the open legs of the half-ring of each repair element end just behind the corresponding repair region, in other words between the driver and one edge of the matrix.

Other advantages and features of the invention are given in the appended description, and illustrated in the appended drawings in which:

FIG. 1, already described, is a synoptic diagram of an active matrix display;

FIG. 2 illustrates the structures for laser repair of open lines of an active matrix, according to the prior art;

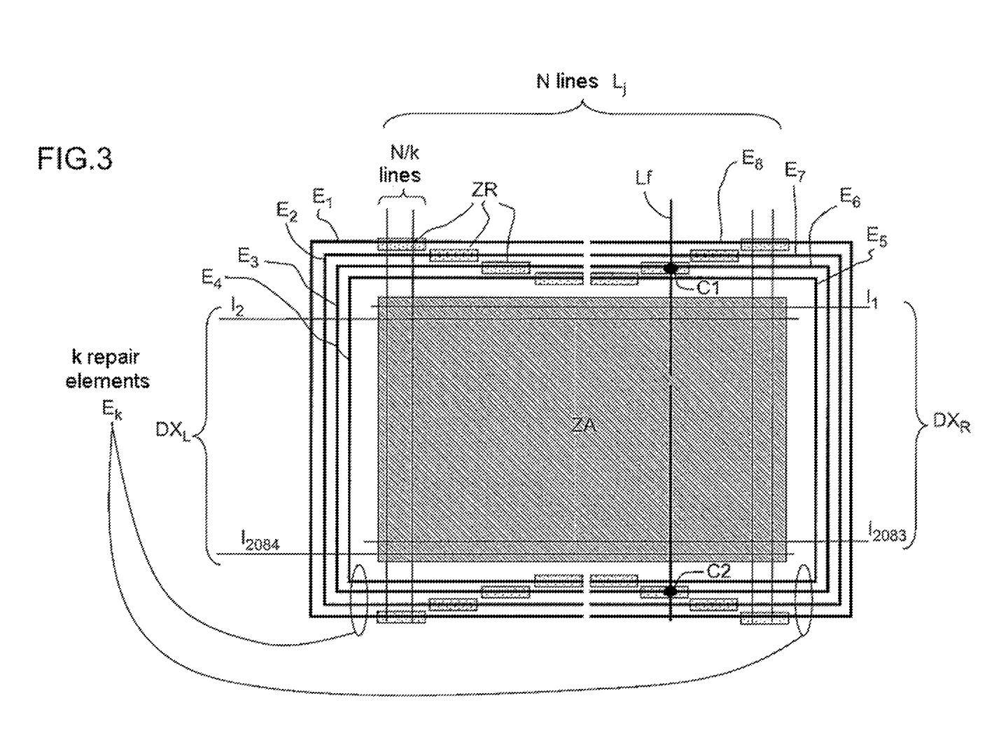

FIG. 3 illustrates a repair structure according to a first embodiment of the invention;

FIGS. 4 to 6 illustrate other embodiments of a repair structure according to the invention;

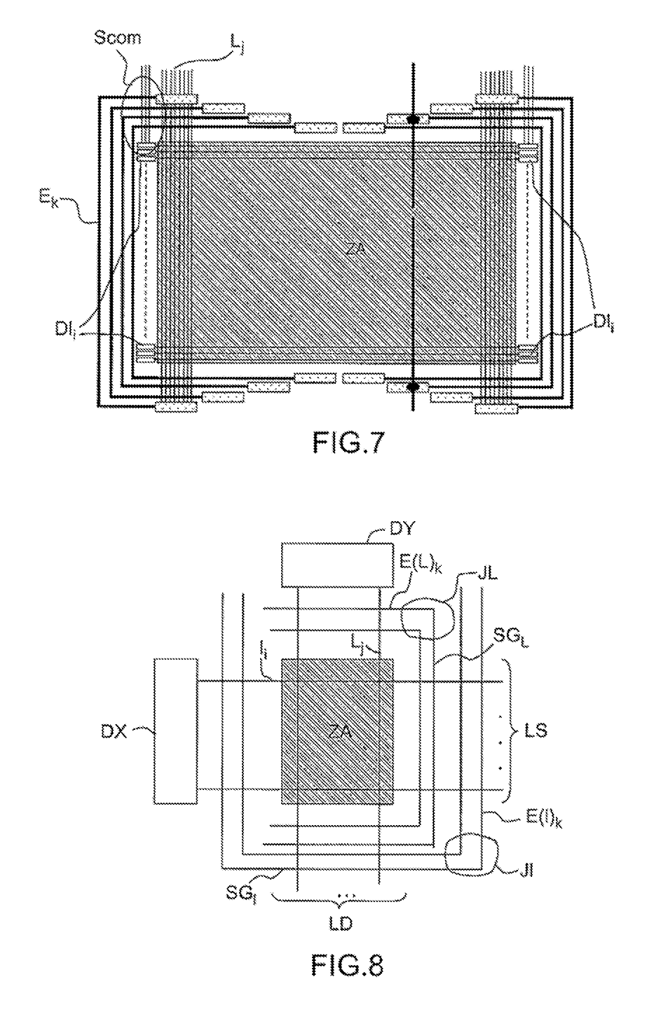

FIG. 7 illustrates one variant applicable to a display with integrated drivers;

FIG. 8 is a block diagram of a display comprising two sets of repair elements according to the invention, one for the repair of the selection lines of the matrix, the other for the repair of the data lines of the matrix;

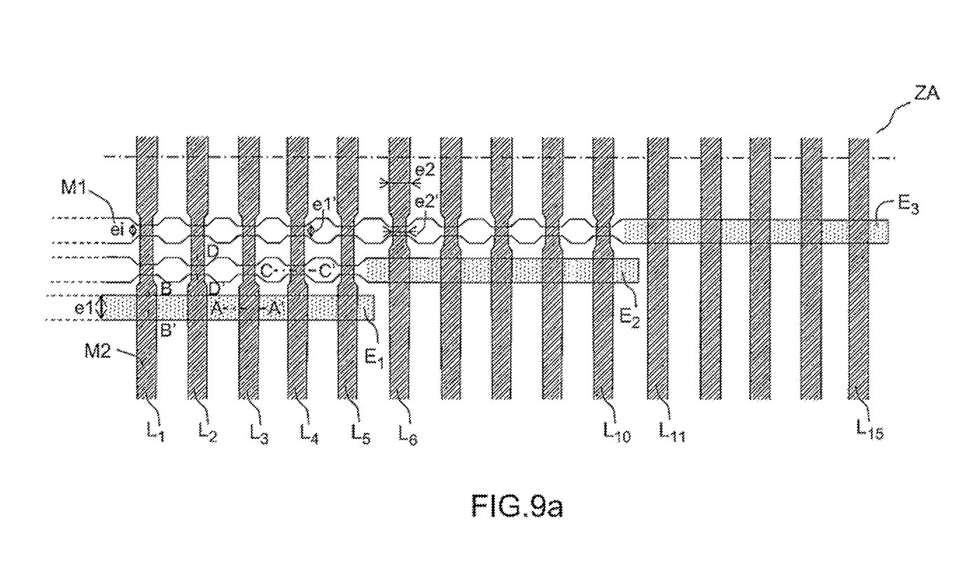

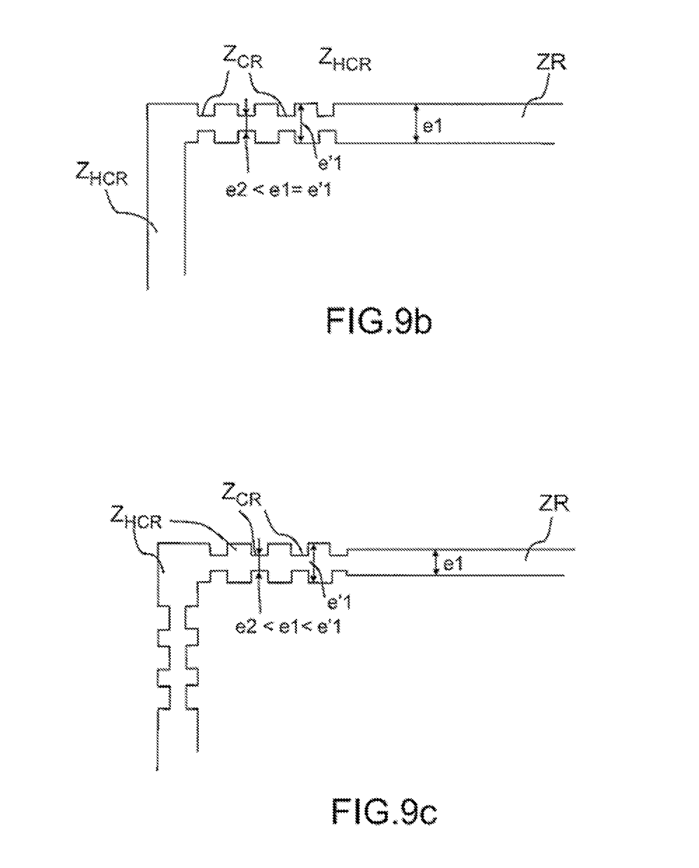

FIGS. 9a to 9c are topological drawings of the repair elements of a repair structure according to the invention; and

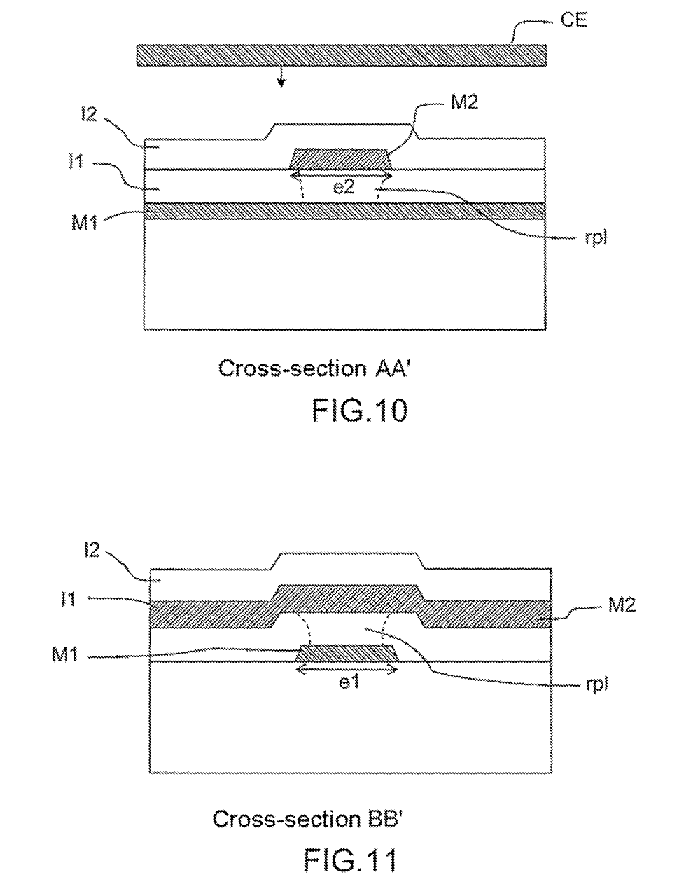

FIGS. 10 and 11 are cross-sectional views in the crossing region, along a line (cross-section AA') and along an open leg (cross-section BB′) outside of a repair region; and

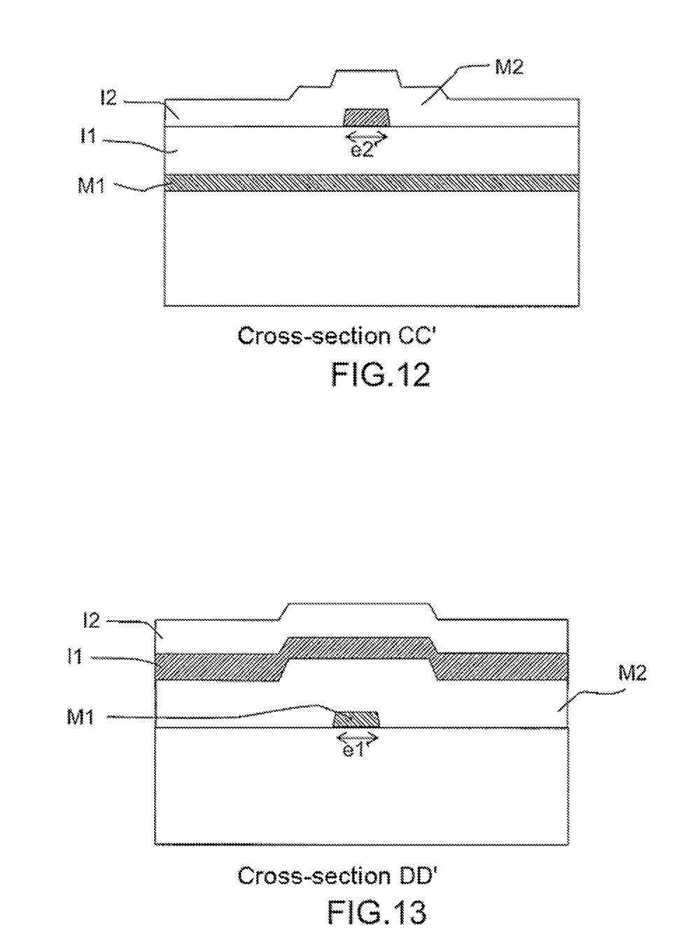

FIGS. 12 and 13 are cross-sectional views in the crossing region, along a line (cross-section AA') and along an open leg (cross-section BB′) within a repair region.

FIG. 3 illustrates a repair structure completely integrated onto the substrate of the active matrix array, according to the invention, in the example, for the repair of the lines Iⱼ running from top to bottom in the figure, in other words typically data lines of the matrix.

According to the invention, for a display comprising N lines Lⱼ, these lines are grouped by groups of N/k successive lines, and a repair element Eₖ is assigned to each group. The repair structure thus comprises k repair elements Eₖ, one per group of N/k lines. The repair element comprises a half-ring whose two open legs, disposed opposite one another on either side of the useful region, cross at least the N/k lines of the group of lines which is assigned to it.

In one example where N equals 3072, 8 groups of 384 columns are thus formed, with one repair element by group, i.e. 8 elements in all, denoted E₁ to E₈ in the figure. If the lines Lⱼ are numbered from 1 to 3072 from left to right, E₁ will for example be assigned to the repair of an open line from amongst the lines 1 to 384, E₂, to the repair of an open line from amongst the lines 385 to 768, E₃, to the repair of an open line from amongst the lines 769 to 1152, and so on and so forth up to E₈, assigned to the repair of an open line from amongst the lines 2689 to 3072.

In the embodiment illustrated in FIG. 3, each repair element is a half-ring. The region on each open leg, where the N/k lines of the group assigned to this repair element cross, is the laser repair region for these lines. These repair regions ZR are indicated by a rectangular frame with a dashed pattern in the figures. This representation of the repair regions in the figures allows the assignment of each repair element to only one group of lines, and the positions of the two repair regions for each repair element, one per open leg, and opposite one another on either side of the useful region ZA, to be clearly illustrated.

An open line, such as the line Lf in the figure, can thus be repaired by carrying out using a laser, in the laser repair region of each of the open legs of the repair element assigned to this line, E₇ in the example, two connections c1 and c2 between this line Lf and each of the open legs.

In this exemplary embodiment, where the repair element is a half-ring, it is noteworthy that the capacitive couplings induced by the crossings between the repair elements and the address lines are minimized, owing to the absence of repair conductor on the side of the useful region opposite to the segment which joins the two open legs of the half-rings: in fact, there is therefore no crossing with address lines on this side of the useful region.

The repair elements are disposed outside of the useful region, and in such a manner that the open legs cross the lines Lⱼ.

Various embodiments are possible, notably by taking into account the specific addressing characteristics of the display, with a view to again minimizing as far as possible the capacitive couplings due to the crossings of the repair elements and the lines. FIGS. 3 to 6 illustrate possible embodiments, taking advantage of the various possibilities for addressing displays. In all these figures, the repair regions ZR of each repair element according to the invention are illustrated as indicated previously, and the useful display region ZA, in stripes.

The embodiment in FIG. 3 is particularly suitable for displays in which the lines Iᵢ of the matrix, which are orthogonal to the lines Lⱼ and correspond to the selection lines for rows of image dots, are addressed some from the left, for example the even lines by a circuit DX_{L}, and the others from the right, for example the odd lines by a circuit DX_{R}.

In this embodiment, half of the repair elements, E₁-E₄, are disposed with the segment attaching the two open legs of the half-ring on the left-hand side of the useful region ZA, and the other half E₅-E₈, with the segment attaching the two open legs of the half-ring on the right-hand side of the useful region. On the left, the repair elements E₁-E₄ can only cross the even lines in the example, such as I₂ and I₂₀₈₄, and the repair elements E₅-E₈, only the odd lines such as and I₂₀₈₃.

FIG. 4 illustrates one variant of this embodiment, in which the open legs of the repair elements are cut off, or end, just after their repair region. The crossing regions are thus reduced to the strict minimum needed, for each repair element to cross at least the group of lines that it has to repair. This creates a variation in coupling over the lines Lⱼ, since the repair elements have lengths which are no longer substantially equal, in contrast to the embodiment in FIG. 3. However, this variation in coupling is not, in practice, an issue in view of the standard conditions for addressing the image dots of the matrix, under which the charging time for a data line Lⱼ is negligible relative to the charging time for the image dots.

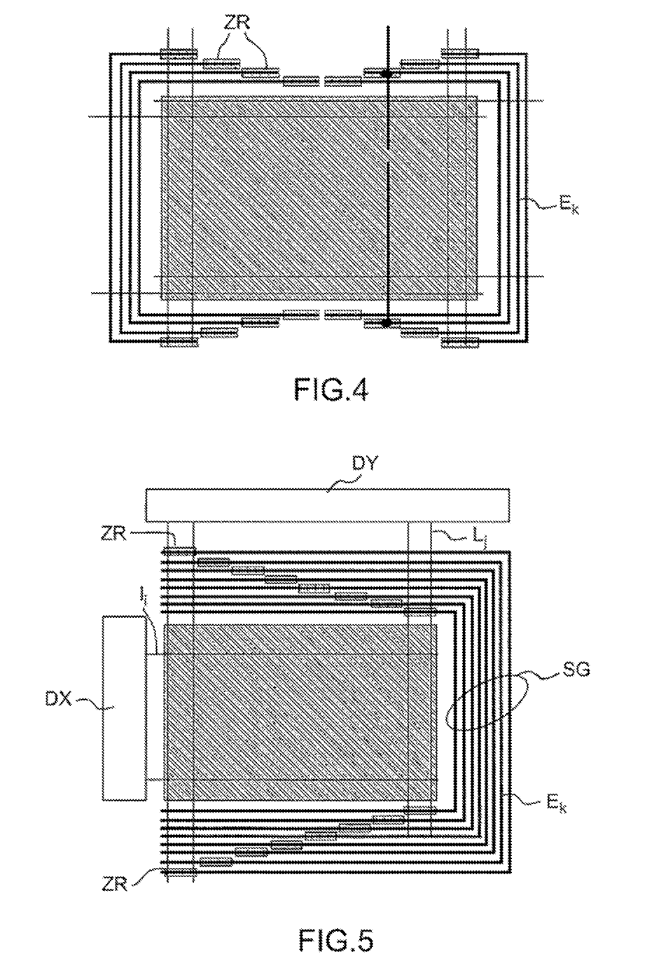

FIG. 5 illustrates another variant of the embodiment in FIG. 3, in which the segments of the repair elements are all on the same side, in the example, the right-hand side. Such an embodiment is particularly suitable for displays in which all the lines Iᵢ of the matrix which are orthogonal to the lines Lⱼ and correspond to the selection lines for rows of image dots, are addressed on the same side by a control circuit DX (or a plurality of control circuits such as the circuits DX1, DX2 in FIG. 2). In this embodiment, the lines Iᵢ do not cross any of the repair elements, and in particular none of the segments SG. The unwanted repair element/address line coupling is thus minimized.

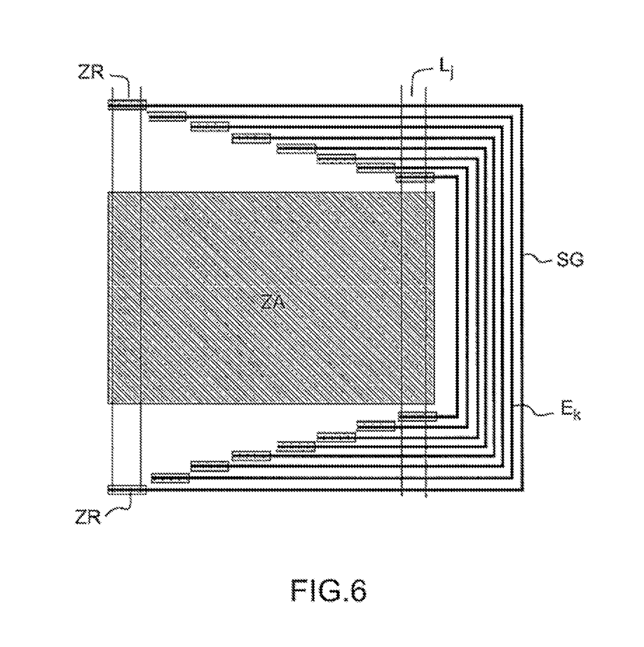

FIG. 6 is a variant of the embodiment in FIG. 5 which corresponds to the variant in FIG. 4, according to which the open legs of each of the repair elements are cut off just after its repair region.

FIG. 7 illustrates another embodiment of the invention, applicable to displays with integrated drivers. The drivers referred to as “integrated drivers” are formed on the active matrix substrate, in the peripheral region between the useful region and one edge of the matrix. In the example more particularly illustrated, there are thus line drivers, denoted DIi in the figure, which drive the lines referred to as selection lines, denoted Ii, on the basis of control signals Scom that they receive from the outside. In this example again, these drivers are duplicated on either side of the active region, which allows the control signals to be transmitted via the two ends of each line Iᵢ. The duplication of the line drivers allows the open-line defect to be directly cured, without having to carry out a repair by laser. Thus, with such a structure, the repair will only be carried out by laser of the open-line defects of the lines Lⱼ.

Advantageously, the repair elements Eₖ for the address lines Lⱼ which are orthogonal to those, Iᵢ, which are driven by these line drivers DIᵢ, are disposed beyond these drivers, in other words between a driver and one edge of the matrix: thus, starting from the active region toward the outside, first of all these drivers DIᵢ, then the repair elements Eₖ are found. This configuration is favorable because the repair elements Eₖ do not then cross any of the lines Iᵢ driven by these drivers DIᵢ, but only the control signals Scom, being of reduced number: the stray coupling capacitance induced by the repair element/address and/or control line crossings is thus optimized (minimized). What is applicable to the repair elements for the lines Lⱼ and to the drivers of the lines Iᵢ is, in the same way, applicable to the repair elements for the lines Iᵢ and for the control drivers of the lines Lⱼ.

The embodiments which have just been described correspond to the repair of the open lines in the lines Lⱼ which correspond to the data lines, via which the video information to be displayed is transmitted. The selection lines Iᵢ by which the rows of image dots on which it is desired to apply new video data are selected, which are usually formed on the surface of the active matrix substrate, are less subject to these open-line defects. Nevertheless, it may be desired to provide a repair structure for these lines.

FIG. 8 thus illustrates an application of the invention to the repair of the open lines of the two sets of lines Iᵢ and Lⱼ of the matrix, with a first set JI of repair elements E(I)ₖ disposed with their segments SG, outside of the useful region, along a side parallel to the lines Iᵢ and a second set JL of repair elements E(L)ₖ, with their segments SG, outside of the useful region, along a side parallel to the lines Lⱼ.

FIGS. 9a to 9c illustrate another aspect of the invention, by which the couplings are minimized by determining, for each repair element, a width of conductor that varies according to whether in a crossing region or not, and in a crossing region of a repair region of the repair element in question or not. The repair regions are shown as grayed areas.

In a more detailed manner, FIG. 9a details the lower open leg of three repair elements E₁, E₂ and E₃, which in the example respectively cross the lines L₀-L₅, L₆-L₁₀, L₁₁-L₁₅.

In the example, these open legs each end after the repair region corresponding to the crossing region with the lines which are assigned to them, for the repair of one of these lines.

According to one aspect of the invention, in the repair region, each repair element has a substantially constant width e1 of the conductor and compatible with a laser repair.

In this repair region, the lines Lᵢ which cross the repair element have a substantially equivalent width e2 of conductor. Typically, the crossing region of the conductors between a repair element and a line that it crosses, and which it is capable of repairing, is of the order of 20×20 or 30×30 square micrometers.

Outside of the repair region, the width of the conductor of the repair element is variable, in such a manner as to optimize the access resistance and/or the coupling capacitance with lines which cross the conductor.

Notably, for each repair element, the aim is to reduce the capacitive coupling between the repair element and each line of the active matrix array that this repair element crosses outside of said repair region: in other words of the lines Lⱼ, and/or of the lines Iᵢ, as long as the repair element crosses these lines, and it is not intended to repair them. According to one aspect of the invention, for each repair element, in each crossing region outside of the repair region, the width of the conductor of the repair element is reduced to a width e1′<e1. Preferably, in this same crossing region, the width of the conductor of the line that the repair conductor crosses at this location, in the example a line Lⱼ, is also reduced to a width e2′<e2. e1′ and e2′ are substantially equal. In one practical example, they are of the order of 4 microns.

According to another aspect of the invention, outside of the repair regions and outside of the crossing regions, t, there will preferably be a larger width of conductor of the repair elements, for example equal to that e1 of the conductors within the repair regions, or even greater, in order to minimize the access resistance of the repair elements.

FIGS. 9b and 9c illustrate schematically the general form of a conductor of a repair element according to the invention, a half-ring in the example, in the surface plane of the active matrix substrate, combining the three characteristics presented hereinabove, depending on the crossing regions with address and/or control lines: width of laser repair, in the repair regions ZR; the largest possible width, optimized for minimum access resistance in the regions outside of crossing areas Z_{HCR}, the narrowest possible width, optimized for minimum coupling capacitance, in the crossing regions outside of repair regions, Z_{CR}. FIG. 9b corresponds to a repair element corresponding to the embodiment illustrated in FIG. 7, in which the repair elements do not cross any of the lines Iᵢ, but control signals Scom of integrated drivers and lines Lⱼ. FIG. 9c corresponds to the embodiment illustrated in FIG. 4, in which the repair elements cross lines Iᵢ and lines Lⱼ. Another element to be taken into account for minimizing the line charges caused by the repair elements is the conducting plane of counter-electrode CE usually formed on another substrate, and which is situated above the last level of the active matrix circuit, as illustrated schematically in FIG. 10. This conducting plane is not always only limited to the useful display region, but may also cover, at least in part, the periphery. The couplings of the repair elements with this conducting plane must then also be taken into account. Notably, the various widths of the conductors outside of repair regions result from a compromise in order to optimize the capacitive coupling and the access resistance. Furthermore, by preferably forming the repair elements on the conductor level furthest from the counter-electrode conducting plane, in other words on the surface of the active matrix substrate, the couplings with the conducting plane are minimized. The various corresponding conducting levels in a crossing region of a repair element with a line are shown in FIGS. 10 and 11, when this is a crossing in a repair region ZR, in a cross-section along the axes AA′ and BB′ in FIG. 9a, and in FIGS. 12 and 13, outside of a repair region, in a cross-section along the axes CC′ and BB′ in FIG. 9a. The repair regions according to the invention are indicated in the grayed areas in the figures.

FIG. 10 shows a cross-section along the repair element E₁, in the crossing region with the line L₃. The repair element is formed by the conductor level M1, directly on the active matrix substrate, which is a transparent glass or plastic. This conductor level will typically be made of Mo, Ti, Al or any combination of these metals or of metals with similar properties (low resistivity, and suitable for soldering). The line E₃ is formed by the conductor level M2, above the level M1 and insulated from this level M1 by at least one insulating layer 11, for example silicon nitride (SiN). At least one other insulating and passivation layer 12 is formed on top of this level M2. As a variant not shown, a local deposition of a slab of amorphous silicon, just under the second conductor level M2, between the levels 11 and M2, in the crossing region of the two conductor levels M1 and M2, improves the insulation between the two levels, without hindering the laser repair.

If there is a laser repair rpl, a hole in the insulator and a welding between the two levels M1 and M2 is formed in the crossing region, as illustrated schematically as dashed lines in the figure.

FIG. 11 shows a crossing region at a repair region, but as a cross-section BB′ along the axis of the repair element, corresponding, in the example, to the crossing of the repair element E₁ and the line L₁.

FIGS. 12 and 13 are cross-sectional views in a crossing region outside of a repair region. FIG. 12 corresponds, in the example, to the crossing of the repair element E₂ and the line L₅. FIG. 13 corresponds, in the example, to the crossing of the repair element E₂ and the line L₂. These two figures show the reduction in the width of the conductors, in order to reduce the surface area of the conductors facing one another, and hence the coupling capacitance. As a variant not shown, a local deposition of a slab of amorphous silicon, just under the second conductor level M2, between the levels 11 and M2, in the crossing region of the two conductor levels M1 and M2, improves the insulation between the two levels.

The invention that has just been described is not limited to the exemplary embodiments presented. Notably, depending on whether the control circuits for the lines are external or internal, depending on whether they are installed on both sides of the lines that they are driving, and according to the respective defect rates of the selection and data lines, and the type of addressing used for each display, the most appropriate repair structure is determined.

Furthermore, although the figures presented illustrate repair elements as half-rings, the invention is not limited to this embodiment. Notably, the half-rings can be closed by any means, for example by external loops, according to the techniques of the prior art (FIG. 1), without straying from the scope of the invention.

1. An active matrix display, the active matrix comprising a useful region (ZA) defined by the crossing region of a first set of lines running in a first direction and of a second set of lines running in a second direction, orthogonal to the first, and elements for repairing open line defects in at least one set of lines amongst said first and second sets, formed on the active matrix substrate outside of said useful display region, where each repair element is a line formed of a half-ring with two open legs disposed opposite one another, on either side of the useful region, wherein for said at least one set of lines:
the lines of said set are divided up into groups of lines,
only one repair element is assigned to each group of lines of said set, allowing the repair of a line in this group of lines, and its two open legs each cross at least the lines of said group of lines to which it is assigned on either side of the useful region,
and
each repair element has a width of conductor which is
substantially constant over the length of a repair region corresponding to the crossing region in which it crosses the lines of the group of lines to which it is assigned, said width in the repair region being defined in order to allow a repair by laser, and
variable outside of this repair region, with a greater width outside of the crossing regions with a conducting line of the matrix than in said crossing regions for optimizing the capacitive coupling and the access resistance of the lines.

2. The display as claimed in claim 1, in which the width of a repair element outside of the crossing regions is equal to or greater than the width within the repair region.

3. The display as claimed in claim 1, of the type with driver(s) integrated onto the active matrix substrate disposed in a peripheral region of the matrix between the useful region and one edge of the matrix, in which the repair elements of a set of lines, from amongst said first and second sets of lines of the active matrix array, are disposed on the active matrix substrate beyond an integrated driver which controls the lines of the other set, between the driver and one edge of the matrix.

4. The display as claimed in claim 1, in which the open legs of the half-ring of each repair element end just behind the corresponding repair region.

5. The display as claimed in claim 1, in which the half-rings of the repair elements are divided with half the segment attaching the open legs on one side of the useful region, and half on the other side.

6. The display as claimed in claim 1, in which the half-rings of the repair elements all have their attaching segment on the same side of the useful region.

7. The display as claimed in claim 1, in which the repair elements are formed on a first conductor level deposited on the surface of the active matrix substrate, and the lines of the matrix cross these conducting elements on a second conductor level above it, separated from said first conductor level by at least one insulating layer.
